(19) United States
(12) Patent Application Publication
(10) Pub. No.: US 2010/0316154 A1
(43) Pub. Date: Dec. 16, 2010

(54) METHOD FOR PERFORMING VIRTUAL MULTIPLE ANTENNA TRANSMISSION IN UPLINK USING FEEDBACK INFORMATION AND MOBILE TERMINAL SUPPORTING THE SAME

(76) Inventors: Sung Ho Park, Anyang-si (KR); Bin Chul Ihm, Anyang-si (KR); Moon Il Lee, Anyangsi (KR); Jae Wan Kim, Anyang-si (KR); Hyun Soo Ko, Anyangsi (KR)

Correspondence Address: MCKENNA LONG & ALDRIDGE LLP, 1900 K STREET, NW, WASHINGTON, DC, 20006, US

(21) Appl. No.: 12/449,346

(22) PCT Filed: Feb. 5, 2008
(86) PCT No.: PCT/KR2008/000748

§ 371 Date: Aug. 4, 2009

Related U.S. Application Data
(60) Provisional application No. 60/888,726, filed on Feb. 7, 2007.

(30) Foreign Application Priority Data
May 11, 2007 (KR) 10-2007-0045944

(51) Int. Cl. H04B 7/02

(52) U.S. Cl. 375/267

(57) ABSTRACT

A method and apparatus for performing virtual multiple antenna transmission using feedback information in a closed-loop multiple antenna system is provided. Virtual multiple antenna control information is fed back from a receiving end that has determined the virtual multiple antenna control information taking into consideration a communication condition of a transmitting end. Virtual multiple antenna transmission is performed in uplink using the feedback information. The transmitting end may also primarily determine at least part of the virtual antenna control information and transmit the determined information to the receiving end. This method allows adaptive virtual multiple antenna transmission suitable for a channel condition in closed-loop uplink, thereby improving the communication performance.

### TECHNICAL FIELD

The present invention relates to a method for performing virtual multiple antenna transmission in uplink using feedback information and a mobile terminal supporting the same.

### BACKGROUND ART

Orthogonal Frequency Division Multiplexing (OFDM) is a communication scheme in which a high-speed serial signal is separated into low-speed parallel signals and the parallel signals are modulated into orthogonal subcarriers to be transmitted and received. While undergoing flat fading, the orthogonal subcarriers separated into narrow bandwidths exhibit excellent characteristics for frequency selective fading channels. In addition, the receiving end does not require a complex equalizer or a rake receiver in a direct sequence-code division multiple access (DS-CDMA) system since the orthogonality between the subcarriers can be maintained using a simple method such as insertion of a guard interval at the transmitting end. Due to these excellent characteristics, OFDM has been employed as a standard modulation method for digital broadcasting, wireless local area network (LAN) such as IEEE 802.11a or HIPERLAN, and fixed broadband wireless access such as IEEE 802.16, etc.

Recently, intensive studies have been conducted on a variety of multiple access schemes based on OFDM. A leading candidate to realize the next-generation mobile communication, among the variety of multiple access schemes, is orthogonal frequency division multiple access (OFDMA) which is a 2D access method combining time-division and frequency-division access technologies.

Such an OFDM/OFDMA system uses a Multiple-Input Multiple-Output (MIMO) technology which can increase the data transfer rate or the data reception performance using multiple antennas at transmitting and receiving ends.

The MIMO technology is classified into a diversity method and a multiplexing method. The diversity method is a technology in which signals, which have undergone different multipath fading, are combined through multiple transmitting/receiving antennas to compensate for a channel deep between paths, thereby increasing the reception performance. Diversity gains obtained by this technology are divided into transmission diversity gains and reception diversity gains depending on whether they are obtained at a transmitting end or a receiving end.

The multiplexing method includes a spatial multiplexing technology in which virtual subchannels are generated between transmitting and receiving antennas for a single terminal and different data is transmitted through each transmitting antenna, thereby increasing channel capacity. Unlike the diversity method, the multiplexing method cannot achieve sufficient gains when only one of the transmitting and receiving ends uses multiple antennas.

One multiplexing method is Collaborative Spatial Multiplexing (CSM). This CSM method is a space-division multiplexing technology which allows two terminals to use the same uplink, thereby increasing the capacity of the system (i.e., the number of terminals available in the system). IEEE 802.16 describes a CSM method in which two terminals, each having one transmit antenna, are handled as a single terminal to perform uplink transmission.

FIG. 1 conceptually illustrates a CSM technique in this case. Here, each terminal includes one power amplifier for one transmit antenna and shares the same uplink wireless resources, thereby allowing the terminal to use the space-division multiplexing technique with only one transmit antenna.

The CSM technique of FIG. 1 can be extended to the case where a terminal includes N transmit antennas and M (M≦N) power amplifiers. FIG. 2 conceptually illustrates an example of the CSM technique where one terminal includes two transmit antennas and two power amplifiers.

As illustrated in FIG. 1, the conventional virtual antenna-based spatial multiplexing technique has a limitation in that it is based on the basic assumption of two terminals, each having one antenna. Even when space-time codes are applied with the extended assumption of terminals, each having two antennas, as illustrated in FIG. 2, the conventional technique cannot actively cope with changes of channel environments since the technique is limited to open-loop systems. This has a problem of difficulty in achieving the optimal performance, especially in low-speed moving environments.

### DISCLOSURE

### Technical Problem

An object of the present invention devised to solve the problem lies on providing a method for performing virtual multiple antenna transmission in uplink using feedback information and a mobile terminal supporting the same, wherein a base station generates control information used for virtual multiple antenna transmission taking into consideration a channel environment of the mobile terminal and feeds the control information back to the mobile terminal, thereby allowing optimal uplink data transmission.

### Technical Solution

The object of the present invention can be achieved by providing a method for performing virtual multiple antenna transmission using feedback information in a closed-loop multiple antenna system, the method including receiving virtual multiple antenna control information fed back from a receiving end that has determined the virtual multiple antenna control information taking into consideration a communication condition of a transmitting end; and performing virtual multiple antenna transmission in uplink using the virtual multiple antenna control information.

Preferably, the communication condition of the transmitting end includes at least one of a channel correlation, a Signal to Interference and Noise Ratio (SINR), a moving speed, and geographical/geometry information.

Preferably, the virtual multiple antenna control information includes at least one of precoding vector/matrix information, a multiplexing rate indicator, a weight, multiple-input multiple-output (MIMO)-related information, a channel coding and modulation scheme, channel quality information, allocated resource information, a pilot pattern, and a retransmission indicator (ACK/NACK). Preferably, the precoding vector/matrix information includes a precoding matrix index (PMI). Preferably, the MIMO-related information includes at least one of a basic transmission technique, a MIMO mode, and an extended MIMO mode.

Preferably, the virtual multiple antenna control information includes information of a precoding vector/matrix selected so as to minimize a correlation of channels of transmitters that are handled as a single transmitter.

Preferably, the virtual multiple antenna control information includes information of a precoding vector/matrix including precoding vector/matrix subsets of transmitters that are handled as a single transmitter.

Preferably, the virtual multiple antenna control information is transmitted through a MIMO UL basic IE message or MIMO UL enhanced IE message.

Preferably, the step of performing the virtual multiple antenna transmission includes selecting a set of transmitters, having a relatively low channel correlation between the transmitters, to perform virtual multiple antenna transmission.

Preferably, the step of performing the virtual multiple antenna transmission includes selecting a set of transmitters, having a relatively high SINR between the transmitters, to perform virtual multiple antenna transmission.

The object of the present invention can also be achieved by providing a method for performing virtual multiple antenna transmission using feedback information in a closed-loop multiple antenna system, the method including transmitting feedforward information, including all or part of virtual antenna control information determined at a transmitting end, to a receiving end; receiving virtual multiple antenna control information fed back from the receiving end that has determined the virtual multiple antenna control information taking into consideration a communication condition of the transmitting end and the feedforward information; and performing virtual multiple antenna transmission in uplink using the fed-back virtual multiple antenna control information.

Preferably, the communication condition of the transmitting end includes at least one of a channel correlation, a Signal to Interference and Noise Ratio (SINR), a moving speed, and geographical information.

Preferably, the virtual multiple antenna control information includes at least one of precoding vector/matrix information, a multiplexing rate indicator, a weight, multiple-input multiple-output (MIMO)-related information, a channel coding and modulation scheme, channel quality information, allocated resource information, a pilot pattern, and a retransmission indicator (ACK/NACK).

The object of the present invention can also be achieved by providing an apparatus for performing virtual multiple antenna transmission using feedback information in a closed-loop multiple antenna system, the apparatus including a receiving circuitry that receives virtual multiple antenna control information fed back from a receiving end that has determined the virtual multiple antenna control information taking into consideration a communication condition of a transmitting end; a memory that stores the fed-back virtual multiple antenna control information; and a controller that performs virtual multiple antenna transmission in uplink using the virtual multiple antenna control information in the memory.

Preferably, the virtual multiple antenna control information includes at least one of precoding vector/matrix information, a multiplexing rate indicator, a weight, multiple-input multiple-output (MIMO)-related information, a channel coding and modulation scheme, channel quality information, allocated resource information, a pilot pattern, and a retransmission indicator (ACK/NACK).

Preferably, the virtual multiple antenna control information is transmitted through a MIMO UL basic IE message or MIMO UL enhanced IE message.

Preferably, the controller selects a set of transmitters, having a relatively low channel correlation between the transmitters, to perform virtual multiple antenna transmission.

Preferably, the controller selects a set of transmitters, having a relatively high SINR between the transmitters, to perform virtual multiple antenna transmission.

### ADVANTAGEOUS EFFECTS

According to the invention, adaptive virtual multiple antenna transmission can be performed through feedback information provided by a base station in a broadband wireless access system, thereby achieving performance optimized for channel conditions.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 conceptually illustrates an example of a conventional CSM technique;

FIG. 2 conceptually illustrates another example of the CSM technique;

FIG. 3 illustrates an example of the configuration of a closed-loop MIMO-OFDMA system which performs virtual multiple antenna transmission according to an embodiment of the invention; and

FIG. 4 is a block diagram of a transmitter in the system of FIG. 3.

### BEST MODE

Reference will now be made in detail to the preferred embodiments of the present invention, examples of which are illustrated in the accompanying drawings.

First, the following technologies can be used for various communication systems. Communication systems are widely deployed to provide various communication services such as voice and packet data services. This technology can be used in downlink or uplink. The downlink means communication from a base station (BS) to a mobile station (MS) and the uplink means communication from a MS to a BS.

The BS is generally a fixed station which communicates with a MS and can be referred to as other terms such as a Node-B, a base transceiver system, or an access point. The MS can be stationary or mobile and can be referred to as other terms such as user equipment (UE), a user terminal (UT), a subscriber station (SS), or a wireless device.

A communication system generally includes a transmitter and a receiver. Here, the transmitter and receiver may be a transceiver which performs both transmitting and receiving functions. In the following description, one side, which is responsible for transmitting general data, is referred to as a transmitter and the other side, which transmits feedback data to the transmitter, is referred to as a receiver to provide clear explanation of feedback.

In downlink, the transmitter may be a part of a BS and the receiver may be a part of a MS. In uplink, the transmitter may be a part of a MS and the receiver may be a part of a BS. The BS may include multiple receivers and multiple transmitters and a MS may also include multiple receivers and multiple transmitters.

The invention can be used for a single-carrier or multi-carrier communication system. The multi-carrier communication system can use orthogonal frequency division multiplexing (OFDM) or other multi-carrier modulation techniques. OFDM partitions a total system bandwidth into multiple orthogonal subcarriers. A subcarrier can be referred to as a subband, a tone, or the like. The single-carrier system can use single-carrier modulation techniques such as single-carrier frequency division multiple access (SC-FDMA) and code division multiple access (CDMA).

Specifically, a virtual multiple antenna transmission method according to the invention can be used in a closed-loop system such as MC-CDMA suggested in the 3rd generation partnership project 2 (3GPP2) or WCDMA, HSDPA, or USDPA suggested in the 3rd generation partnership project (3GPP). The virtual multiple antenna transmission method according to the invention can also be applied to Wibro, a Korean standard, or Wimax suggested in the Institute of Electrical and Electronics Engineers (IEEE) under the assumption of a closed-loop system in uplink.

On the other hand, IEEE 802.16e is in progress as an international standard of broadband wireless access systems for accomplishing next-generation mobile Internet services. Especially, much attention is being paid to studies on OFDMA systems and MIMO technologies for accomplishing transmission of a great deal of data.

The OFDMA system suggested in the IEEE 802.16e is a time division duplex (TDD) system. In this system, a frame is time-divided into a downlink interval and an uplink interval and the ratio of resources allocated to the uplink to those of the downlink is about 2:1. The OFDMA system supports multiple access by allocating subcarriers of each symbol respectively to MSs of users. A basic allocation unit of subcarriers allocated to MSs is defined as a subchannel and the Fast Fourier Transform (FFT) size can be selected flexibly according to the channel environment.

The MIMO technology can be classified into a spatial multiplexing technique and a transmit diversity technique. The transmit diversity technique transmits a single input signal through an appropriate encoding process, thereby providing excellent reception performance. On the other hand, the spatial multiplexing technique divides an input signal into multiple parallel signals and then transmits the divided signals simultaneously. Although this spatial multiplexing technique increases the data transfer rate, it provides lower performance than the spatial multiplexing technique in terms of link reliability.

The MIMO-OFDMA system suggested in the IEEE 802.16e can increase the data transfer rate or reception performance using time/frequency and other spatial resources. As a specific example, the MIMO-OFDMA system provides space-time transmit diversity (STTD), spatial multiplexing, and collaborative spatial multiplexing (CSM) techniques for uplink communication.

In the STTD, two or more signals are transmitted through two or more antennas while diversity gain is achieved using antenna and time domain information. In the SM, different signals are simultaneously transmitted through different transmit antennas. In the CSM, two or more MSs, each having one or more transmit antennas, simultaneously transmit data through the same frequency resources. The CSM suggested in the IEEE 802.16e is based on a open-loop system and is characterized in that no transmitter channel environment is taken into consideration when a virtual antenna is constructed. Reference will now be made to embodiments of a method for constructing virtual antennas using feedback information which reflects transmitter channel environments in a closed-loop system in uplink.

### Embodiment 1

This embodiment relates to the case where a transmitter includes multiple antennas which are all used to transmit data. Accordingly, the transmitter includes the same number of power amplifiers as that of the number of the transmit antennas.

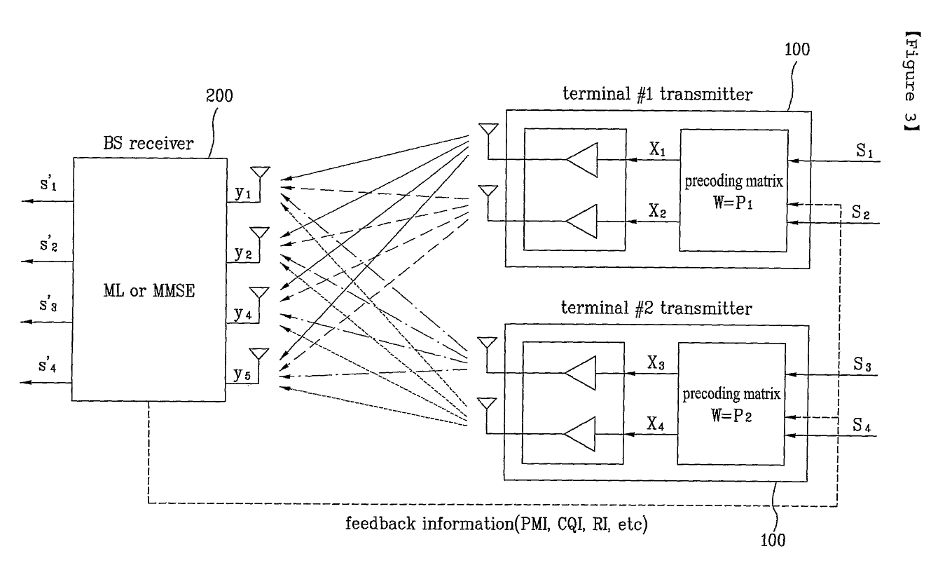

FIG. 3 illustrates the configuration of a closed-loop MIMO-OFDMA system which performs virtual multiple antenna transmission according to this embodiment.

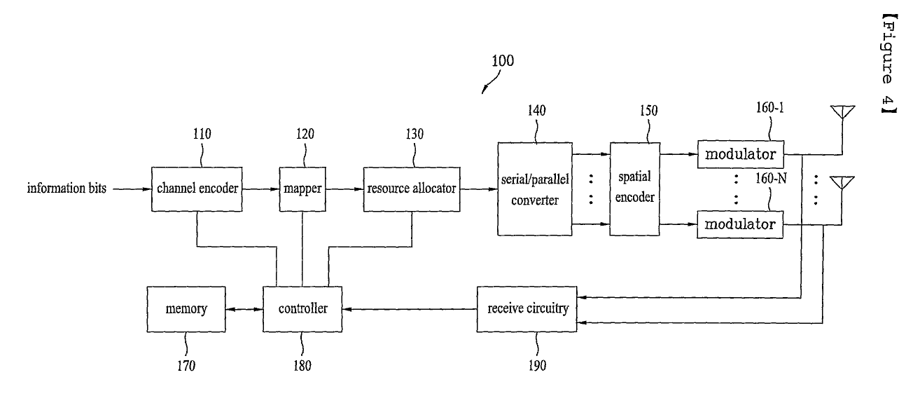

In FIG. 3, a transmitter 100 receives feedback information used for virtual multiple antennas control from a receiver 200 and performs virtual multiple antenna transmission using the feedback information. The configuration of the transmitter 100 is described below in more detail with reference to FIG. 4.

The transmitter 100 includes a channel encoder 110, a mapper 120, a resource allocator 130, a serial/parallel converter 140, a spatial encoder 150, N (N≧1) modulators 160-1, . . . , 160-N, a memory 170, a controller 180, a receive circuitry 190, and Nₜ (Nₜ≧1) antennas.

The channel encoder 110 receives a stream of information bits and encodes the information bits according to a predetermined coding scheme to create coded data. The information bits may include text, audio, video, or other data.

The mapper 120 modulates the coded data of the information bit stream according to a predetermined modulation scheme to provide transmit symbols. Here, the mapper 120 maps the encoded data to symbols representing positions based on amplitude and phase constellation. The modulation method is not limited to any specific method and may include m-quadrature phase shift keying (m-PSK) or m-quadrature amplitude modulation (m-QAM).

The resource allocator 130 allocates resources to a transmit symbol according to a resource allocation scheme reported by the controller 180. The resource allocation scheme may include a consecutive allocation scheme, a distributed allocation scheme, and a group allocation scheme. A frequency (or time) hopping technique may be applied to these schemes.

The serial/parallel converter 140 converts input serial data into parallel data so as to be distributed over multiple antennas.

The spatial encoder 150 processes blocks of modulation symbols according to a space-time coding scheme so that they can be transmitted through multiple antennas. A set of symbols, which are transmitted in a single period (or single time slot) according to the output of the spatial encoder 150, is hereinafter referred to as a transmit symbol.

The modulators 160-1, ? 160-N modulate transmit symbols according to a multiple access modulation scheme. The multiple access modulation scheme is not limited to any specific scheme and may include a single-carrier modulation scheme such as CDMA or a multi-carrier modulation scheme such as OFDM.

The memory 170 has a space for temporarily storing feedback information received from the receiver 200. The feedback information includes at least one of precoding vector/matrix information, a multiplexing rate indicator, a weight, MIMO-related information, which is applied to a virtual multiple antenna transmission technique, a channel coding and modulation scheme, allocated resource information, a pilot pattern, channel quality information, and a retransmission indicator (ACK/NACK). Here, it is preferable that either the precoding vector/matrix information or the weight be included in the feedback information.

Although the precoding vector/matrix information included in the feedback information may be a precoding vector/matrix, the precoding vector/matrix information may also be an index indicating a specific precoding vector/matrix in the case where a number of precoding vectors/matrices are stored in the form of a codebook in the memory 170. The precoding vector/matrix can be generalized as follows.

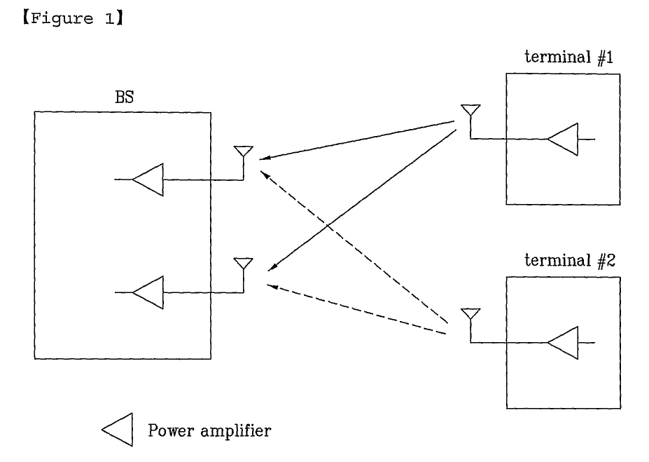

w_{nTx×1}=[C_{UE#k}_{_{(nTx×Rank#r)}}], [Math Figure 1]

where “C”? denotes a precoding vector/matrix of each transmitter 100, conditions of wₗεW: {wₗ, . . . , w_{L}} and lε{1, . . . , L} are satisfied, “L”? denotes the size of the codebook, conditions of K+R≦min(nTx_UE, nRx_BS) and (kε{0, . . . , K}, rε{0, . . . , R}) are satisfied, “nTx_UE” denotes the number of transmit antennas of the transmitter 100, and nRx_BS denotes the number of receive antennas.

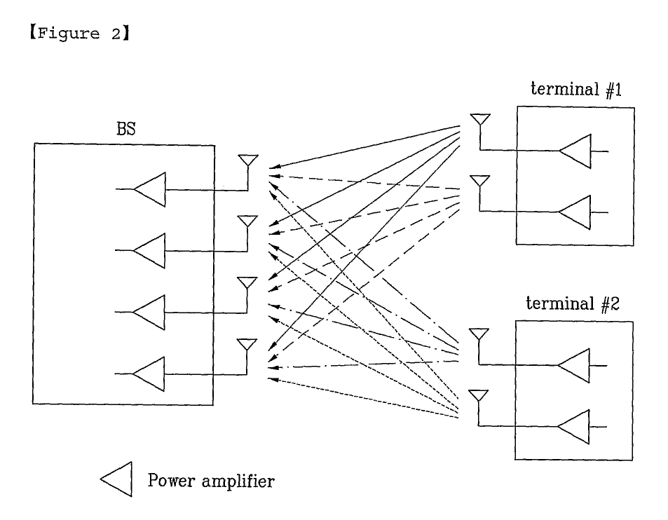

Mathematical Expression 2 is a specific representation of Mathematical Expression 1 when the number of transmit antennas is 2 and the multiplexing rate is 2.

$${W}_{l} = {( \begin{matrix}a {e}_{ue \#1 \_ T x1 \_ Stream 1}^{{jθ}_{1}} & b {e}_{ue \#1 \_ T x1 \_ Stream 2}^{{jθ}_{2}} \\ c {e}_{ue \#1 \_ T x1 \_ Stream 1}^{{jθ}_{3}} & d {e}_{ue \#1 \_ T x2 \_ Stream 2}^{{jθ}_{4}}\end{matrix} )}_{l} \qquad [ Math Figure 2 ]$$

Mathematical Expression 2 can be expressed as follows when the multiplexing rate is 1.

$${W}_{l} = {( \begin{matrix}a {e}_{ue \#1 \_ T x1 \_ Stream 1}^{{jθ}_{1}} \\ c {e}_{ue \#1 \_ T x1 \_ Stream 1}^{{jθ}_{3}}\end{matrix} )}_{l} \qquad [ Math Figure 3 ]$$

In Mathematical Expressions 2 and 3, “a”, “b”, “c”, and “d” denote amplitudes with real values and “θᵢ (i=1, 2, 3, 4)” represents a phase value.

The MIMO-related information may include at least one of a basic transmission technique, a MIMO mode, and an extended MIMO mode. The basic transmission technique may be one of spatial multiplexing (MIMO-SM), spatial diversity (MIMO-STC), precoding (MIMO-Precoding), and other techniques. For example, one of the spatial multiplexing and spatial diversity techniques can be set as the basic transmission technique when the current communication mode is open-loop and one of the spatial multiplexing and precoding techniques can be set when the current communication mode is closed-loop. The MIMO mode may be an indicator of whether the current communication mode is open-loop or closed-loop. The extended MIMO mode may be an indicator of whether or not the MIMO mode is single-user MIMO (SU-MIMO) or multi-user MIMO (MU-MIMO).

The channel quality information (CQI) is channel environment, coding mode, or modulation scheme-related information that the receiver feeds back to the transmitter 100. Specifically, the channel quality information (CQI) may correspond to at least one of information of the power of each channel, information of the Signal to Noise Ratio (SNR) of each channel, a specific coding rate, and/or index information indicating a modulation scheme or size. A Signal to Interference and Noise Ratio (SINR) can be used instead of the SNR. A Modulation and Coding Scheme (MCS) level index can be used as the index information.

The receive circuitry 190 receives a signal transmitted by the receiver 200 through an antenna and converts it into a digital signal and transfers the digital signal to the controller 180. Here, the transmitter 100 may have nTx antennas (nTx≧1) and the number of power amplifiers is less than or equal to nTx.

The controller 180 controls the components of the transmitter 100 to allow the transmitter 100 to operate normally. Especially, the controller 180 receives feedback information through the receive circuitry 190 and causes the transmitter 100 to perform virtual multiple antenna transmission using the received feedback information.

Specifically, the controller 180 checks the pilot pattern included in the feedback information to determine that the feedback information is destined for the transmitter 100. Then, the controller 180 can select a specific precoding vector/matrix from the codebook according to the precoding vector/matrix information included in the received feedback information or can select a specific column of the selected precoding vector/matrix according to the multiplexing rate indicator to reconstruct a precoding vector/matrix. If the feedback information includes a weight instead of the precoding vector/matrix information, the weight is applied to a subcarrier symbol of each transmit antenna.

The controller 180 controls the channel encoder 110 and the mapper 120 so as to comply with the channel coding and modulation scheme included in the feedback information and transmits data in uplink using the virtual multiple antenna transmission technique specified in the feedback information. This data transmission is performed through resources corresponding to the allocated resource information specified in the feedback information.

On the other hand, the receiver 200 includes a channel decoder (not shown), a demapper (not shown), a demodulator (not shown), a memory (not shown), a controller (not shown), and a transmit circuitry (not shown). Here, the channel decoder, the demapper, the demodulator, and the transmit circuitry perform the reverse functions of the channel encoder 110, the mapper 120, the modulator 140, and the receive circuitry 190 of the transmitter 110 described above. A description of these reverse functions is omitted herein since they are apparent to those skilled in the art.

The controller of the receiver 200 determines at least one of the channel correlation, SINR, moving speed, and geographical information of transmitters which will be handled as a single transmitter as the virtual multiple antenna transmission technique is applied. The controller of the receiver 200 creates the feedback information taking into consideration the determined information and transmits the feedback information to each transmitter over downlink. For example, the controller of the receiver can take into consideration at least one of the fairness of selection and the SINR when selecting each transmitter and resources to be allocated to the transmitter. In addition, in order to pair transmitters to which the virtual multiple antenna technique is to be applied, the controller of the receiver can take into consideration at least one of correlations between channels of transmitters and the SINRs of the transmitters when the virtual multiple antenna technique is applied to select and pair transmitters in order to have a relatively low correlation or a relatively high SINR.

Especially, in the case where the moving speed of the transmitter in the feedback information is high, it is preferable that feedback information or feedforward information be set so as to fix the precoding vector/matrix index or to switch to an open-loop system since the efficiency of the adaptive virtual multiple antenna technique through the provision of the feedback information is low in such a case.

In addition, in the case where the channel condition is bad, especially where the transmitter is distant from the receiver, the transmitter/receiver can no longer accommodate multiple users and therefore the efficiency of MU-MIMO including the virtual multiple antenna technique is low. Accordingly, it is preferable that feedback information or feedforward information be set so as to switch to SU-MIMO in such a case.

### Embodiment 2

This embodiment relates to the case where a precoding vector/matrix is provided through feedback information to terminals which are handled as a single terminal according to the virtual multiple antenna transmission technique.

In an example, different precoding vectors/matrices can be provided through feedback information to terminals which are handled as a single terminal according to the virtual multiple antenna transmission technique. In this case, the precoding vectors/matrices can be selected and transmitted so as to minimize or lower the correlation of channels of terminals.

In another example, when terminals, which are handled as a single terminal according to the virtual multiple antenna transmission technique, communicate with each other, a precoding vector/matrix commonly applied to the terminals can be provided through feedback information to the terminals. In this case, the precoding vector/matrix includes a set of precoding vector/matrix subsets of the terminals which are handled as a single terminal according to the virtual multiple antenna transmission technique.

For example, when two terminals are handled as a single terminal according to the virtual multiple antenna transmission technique, a precoding vector/matrix commonly provided to the terminals is expressed as follows.

$${ω}_{nTx \times 1} = [ \begin{matrix}{C}_{UE {\#1}_{( nTx \times Rank \# r )}} \\ {C}_{UE {\#2}_{( nTx \times Rank \# r )}}\end{matrix} ] , \qquad [ Math Figure 4 ]$$

where r≦min(nTx_UE, nRx_BS)

Mathematical Expression 5 is a specific representation of the precoding vector/matrix of Mathematical Expression 4 when the multiplexing rate is 2.

$${W}_{l} = {( \begin{matrix}a {e}_{ue \#1 \_ T x1 \_ Stream 1}^{{jθ}_{1}} & b {e}_{ue \#1 \_ T x1 \_ Stream 2}^{{jθ}_{2}} \\ c {e}_{ue \#1 \_ T x1 \_ Stream 1}^{{jθ}_{3}} & d {e}_{ue \#1 \_ T x2 \_ Stream 1}^{{jθ}_{4}} \\ ⋯ & ⋯ \\ p {e}_{ue \#2 \_ T x1 \_ Stream 1}^{{jθ}_{1}} & q {e}_{ue \#2 \_ T x1 \_ Stream 2}^{{jθ}_{2}} \\ r {e}_{ue \#2 \_ T x 2 \_ Stream 1}^{{jθ}_{3}} & s {e}_{ue \#2 \_ T x 2 \_ Stream 2}^{{jθ}_{4}}\end{matrix} )}_{l} \qquad [ Math Figure 5 ]$$

An upper part above the dotted lines in Mathematical Expression 5 is a precoding vector/matrix subset applied to the first terminal and a lower part below the dotted lines is a precoding vector/matrix subset applied to the second terminal. In this manner, each of the first and second terminals receives not only a precoding vector/matrix subset for the corresponding terminal but also a precoding vector/matrix subset for the other terminal which will be paired with the corresponding terminal. As a result, precoding matrices of the same structure are provided to the first and second terminals.

The following represents an example of Mathematical Expression 5 when the multiplexing rate is 1.

$${W}_{l} = {( \begin{matrix}a {e}_{ue \#1 \_ T x1 \_ Stream 1}^{{jθ}_{1}} \\ c {e}_{ue \#1 \_ T x1 \_ Stream 1}^{{jθ}_{3}} \\ ⋯ \\ p {e}_{ue \#2 \_ T x1 \_ Stream 1}^{{jθ}_{1}} \\ r {e}_{ue \#2 \_ T x1 \_ Stream 1}^{{jθ}_{3}}\end{matrix} )}_{l} \qquad [ Math Figure 6 ]$$

As can be seen from Mathematical Expression 6, this example is characterized in that a precoding matrix subset applied to the first terminal and a precoding matrix subset applied to the second terminal are combined to be commonly provided to the two terminals although the multiplexing rate is reduced to “1” so that a specific column of the precoding matrix is selected.

In Mathematical Expressions 5 and 6, conditions of wₗεW: {wₗ, . . . , w_{L}} and lε{1, . . . , L} are satisfied, L denotes the size of the codebook, a, b, c, d, p, q, r, and s denote amplitudes with real values and θᵢ (i=1, 2, 3, 4) represents a phase value.

### Embodiment 3

This embodiment relates to the case where the receiver 200 uses a MIMO UL basic IE message in order to transmit feedback information to the transmitter 100. Also, a MIMO UL enhanced IE message may be used to transmit feedback information.

In a broadband wireless access system using OFMD/OFDMA, feedback information can be transmitted in the downlink through a MIMO UL basic IE message. Here, the following two examples can be implemented according to the number of bits allocated to a Collaborative_SM_Indication item in the MIMO UL basic IE message. The Collaborative_SM_Indication item is just an example item for carrying feedback information and the term can be replaced with “Collaborative_MIMO_Indication”? or the like. The following description will be given using the Collaborative_MIMO_Indication item.

First, when the Collaborative_MIMO_Indication item is 2 bits, non-collaborative MIMO, collaborative MIMO_SM, collaborative MIMO-STC, or collaborative MIMO-Pre coding can be identified and set according to the value of the item. Table 1 shows an example format of the MIMO UL basic IE message in this case.

TABLE 1

| Syntax | | Size | | Notes |
|---|---|---|---|---|
| | MIMO_UL_Basic_IE ( ) { | | | |
| | Extended DUIUC | 4 | bits | MIMO = 0x026 |
| | Length | 4 | bits | |
| | Num_Assign | 4 | bits | Number of burst |

assignment

For (j = 0; j <Num_assign; j++)

{

| | | | |
|---|---|---|---|
| Collaborative_MIMO_Indication | 2 | bits | 00: Non collaborative |

MIMO (Vertical coding
assignment to a MIMO
capable SS)
01: Collaborative
MIMO-SM (assignment to 2
collaborative MIMO
capable SSs)
10: Collaborative
MIMO-STC (assignment to 2
collaborative MIMO
capable SSs)
11: Collaborative
MIMO-Precoding (assignment to 2
collaborative MIMO
capable SSs)

If

(Collaborative_MIMO_Indication
== 0) {

| | | | |
|---|---|---|---|
| CID | 16 | bits | SS basic CID |
| UIUC | 4 | bits | |
| MIMO_Control | 1 | bit | For dual transmission |

capable SS
0: STTD
1: SM

} Else {

| CID_A | 16 | bits | Basic CID of SS that |
|---|---|---|---|
| | | | shall use pilot pattern A |
| UIUC_A | 4 | bits | UIUC used for the |
| | | | allocation that uses |
| | | | pilot pattern A |
| CID_B | 16 | bits | Basic CID if SS that |
| | | | shall use pilot pattern B |
| UIUC_B | 4 | bits | UIUC used for the |

allocation that uses
pilot pattern B

}

| | | | |
|---|---|---|---|
| Duration | 10 | bits | In OFDMA slots |

(see 8.4.3.1)

}

| | | |
|---|---|---|
| padding | Variable | Number of bits |

required to align to byte
length, shall be set to
zero

}

Table 2 shows the setting values of operating modes of the MIMO UL basic IE message in this case.

TABLE 2

| | | | | | | |
|---|---|---|---|---|---|---|
| | Number | | | | | |
| | of | | | | | |
| | Tx | | | | | |
| | antennas | | | | | |
| | per | | | | Coding | |
| Mode | SS | Collaborative_MIMO_Indication | MIMO_control | CIDs | Type | Rate |

Collaborative

| | | | | | | |
|---|---|---|---|---|---|---|
| MIMO, | 1_or 2 | 1, 2, 3 | N/A | CID_A ! = | Two SS, | 1 |
| 2 SSs | | | | CID_B | each | or 2 |
| | | | | | transmits | per |
| | | | | | from | SS |
| | | | | | antenna | |
| | | | | | #0 and/or | |
| | | | | | antenna #1 | |

Spatial
Multiplexing,

| | | | | | | |
|---|---|---|---|---|---|---|
| Vertical | 2 | 0 | 1 | Single | SM with | 2 |
| coding | | | | CID | Vertical | |
| | | | | | coding | |
| | | | | | for | |
| | | | | | Single user | |
| STTD | 2 | 0 | 0 | Single | STTD | 1 |
| | | | | CID | | |

For example, in the case of Embodiment 2 where the number of transmit antennas is 2 and the number of power amplifiers is 1, especially when a Collaborative_MIMO_Indication item of the MIMO UL basic IE message, which has been set to one of 01, 10, and 11, is transmitted to the transmitter 100, the operating mode of the transmitter 100 becomes a collaborative MIMO mode so that the number of transmit antennas, a CSM indicator, MOMO control, a CID, a coding type, and a multiplexing rate of each transmitter can be set to specific values according to Table 2.

Second, when the Collaborative_SM_Indication item is 1 bit, non-collaborative MIMO or collaborative MIMO-SM can be identified and set according to the value of the item. Table 3 shows an example format of the MIMO UL basic IE message in this case.

TABLE 3

| Syntax | | Size | | Notes |
|---|---|---|---|---|
| | MIMO_UL_Basic_IE ( ) { | | | |
| | Extended DUIUC | 4 | bits | MIMO = 0x026 |
| | Length | 4 | bits | |
| | Num_Assign | 4 | bits | Number of burst |

assignment

For (j=0; j<Num_assign;

j++) {

| | | | |
|---|---|---|---|
| Collaborative_MIMO_Indication | 1 | bit | 0: Non |

collaborative MIMO
(Vertical coding
assignment to a MIMO
capable SS)
1: Collaborative
MIMO (assignment to 2
collaborative MIMO
capable SSs)

If

(Collaborative_MIMO_Indication
== 0) {

| | | | |
|---|---|---|---|
| CID | 16 | bits | SS basic CID |
| UIUC | 4 | bits | |
| MIMO_Control | 1 | bit | For dual |

transmission capable
SS
0: STTD
1: SM

} Else {

| CID_A | 16 | bits | Basic CID of SS |
|---|---|---|---|
| | | | that shall use pilot |
| | | | pattern A |
| UIUC_A | 4 | bits | UIUC used for the |
| | | | allocation that uses |
| | | | pilot pattern A |
| CID_B | 16 | bits | Basic CID of SS |
| | | | that shall use pilot |
| | | | pattern B |
| UIUC_B | 4 | bits | UIUC used for the |
| | | | allocation that uses |
| | | | pilot pattern B |
| MIMO_Control | 2 | bits | 0: STTD |

1: SM
2: Precoding

}

| | | | |
|---|---|---|---|
| Duration | 10 | bits | In OFDMA slots |

(see 8.4.3.1)

}

| | | |
|---|---|---|
| padding | Variable | Number of bits |

required to align to
byte length, shall be
set to zero

}

For example, in the case where the number of transmit antennas is 2 and the number of power amplifiers is 1, especially when a Collaborative_MIMO_Indication item of the MIMO UL basic IE message, which has been set to “0”, is transmitted to the transmitter 100, 1 bit can be allocated to a MIMO control item indicating the operating mode of the transmitter 100. Specifically, dual transmission through each antenna can be set when no value is assigned to the MIMO control item (N/A), STTD can be set when the value of the MIMO control item is 0, and SM can be set when the value is 1.

In addition, when a Collaborative_MIMO_Indication item of the MIMO UL basic IE message, which has been set to “1”, is transmitted to the transmitter 100, 2 bits can be allocated to a MIMO control item indicating the operating mode of the transmitter 100. Specifically, STTD can be set when the value of the MIMO control item is 0, SM can be set when the value is 1, and Precoding can be set when the value is 2.

### Embodiment 4

This embodiment is implemented such that the transmitter 100 primarily determines at least part of virtual antenna control information including MIMO-related information such as a MIMO mode and an extended MIMO mode and transmits the determined information to the receiver 200 so as to perform the above procedure, while the above Embodiments 1 to 3 are implemented such that the receiver 200 determines feedback information items such as a precoding vector/matrix, a multiplexing rate, and a weight required for virtual multiple antenna transmission taking into consideration the channel correlation, SINR, moving speed, retransmission indicator, etc., of the transmitter 100. However, in this embodiment, the transmitter 100 may suffer from overhead due to the determination of such items.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As is apparent from the above description, the invention performs adaptive virtual multiple antenna transmission through feedback information provided by a base station in a broadband wireless access system, thereby achieving performance optimized for channel conditions and thus can be applied to any devices such as terminals or base stations associated with wireless access systems and their relevant algorithms.

1. A method for performing virtual multiple antenna transmission using feedback information in a closed-loop multiple antenna system, the method comprising:
receiving virtual multiple antenna control information fed back from a receiving end that has determined the virtual multiple antenna control information taking into consideration a communication condition of a transmitting end; and
performing virtual multiple antenna transmission in uplink using the virtual multiple antenna control information.

2. The method according to claim 1, wherein the communication condition of the transmitting end includes at least one of a channel correlation, a Signal to Interference and Noise Ratio (SINR), a moving speed, and geographical information.

3. The method according to claim 1, wherein the virtual multiple antenna control information includes at least one of precoding vector/matrix information, a multiplexing rate indicator, a weight, multiple-input multiple-output (MIMO)-related information, a channel coding and modulation scheme, channel quality information, allocated resource information, a pilot pattern, and a retransmission indicator (ACK/NACK).

4. The method according to claim 3, wherein the precoding vector/matrix information includes a precoding matrix index (PMI).

5. The method according to claim 3, wherein the MIMO-related information includes at least one of a basic transmission technique, a MIMO mode, and an extended MIMO mode.

6. The method according to claim 1, wherein the virtual multiple antenna control information includes information of a precoding vector/matrix selected so as to minimize a correlation of channels of transmitters that are handled as a single transmitter.

7. The method according to claim 1, wherein the virtual multiple antenna control information includes information of a precoding vector/matrix including precoding vector/matrix subsets of transmitters that are handled as a single transmitter.

8. The method according to claim 1, wherein the virtual multiple antenna control information is transmitted through a MIMO UL basic IE message or a MIMO UL enhanced IE message.

9. The method according to claim 1, wherein the step of performing the virtual multiple antenna transmission includes selecting a set of transmitters, having a relatively low channel correlation between the transmitters, to perform virtual multiple antenna transmission.

10. The method according to claim 1, wherein the step of performing the virtual multiple antenna transmission includes selecting a set of transmitters, having a relatively high SINR between the transmitters, to perform virtual multiple antenna transmission.

11. A method for performing virtual multiple antenna transmission using feedback information in a closed-loop multiple antenna system, the method comprising:
transmitting feedforward information, including all or part of virtual antenna control information determined at a transmitting end, to a receiving end;
receiving virtual multiple antenna control information fed back from the receiving end that has determined the virtual multiple antenna control information taking into consideration a communication condition of the transmitting end and the feedforward information; and
performing virtual multiple antenna transmission in uplink using the fed-back virtual multiple antenna control information.

12. The method according to claim 11, wherein the communication condition of the transmitting end includes at least one of a channel correlation, a Signal to Interference and Noise Ratio (SINR), a moving speed, and geographical information.

13. The method according to claim 11, wherein the virtual multiple antenna control information includes at least one of precoding vector/matrix information, a multiplexing rate indicator, a weight, multiple-input multiple-output (MIMO)-related information, a channel coding and modulation scheme, channel quality information, allocated resource information, a pilot pattern, and a retransmission indicator (ACK/NACK).

14. An apparatus for performing virtual multiple antenna transmission using feedback information in a closed-loop multiple antenna system, the apparatus comprising:
a receiving circuitry that receives virtual multiple antenna control information fed back from a receiving end that has determined the virtual multiple antenna control information taking into consideration a communication condition of a transmitting end;
a memory that stores the fed-back virtual multiple antenna control information; and
a controller that performs virtual multiple antenna transmission in uplink using the virtual multiple antenna control information in the memory.

15. The apparatus according to claim 14, wherein the virtual multiple antenna control information includes at least one of precoding vector/matrix information, a multiplexing rate indicator, a weight, multiple-input multiple-output (MIMO)-related information, a channel coding and modulation scheme, channel quality information, allocated resource information, a pilot pattern, and a retransmission indicator (ACK/NACK).

16. The apparatus according to claim 14, wherein the virtual multiple antenna control information is transmitted through a MIMO UL basic IE message a MIMO UL enhanced IE message.

17. The apparatus according to claim 14, wherein the controller selects a set of transmitters, having a relatively low channel correlation between the transmitters, to perform virtual multiple antenna transmission.

18. The apparatus according to claim 14, wherein the controller selects a set of transmitters, having a relatively high SINR between the transmitters, to perform virtual multiple antenna transmission.
